(19) United States
(12) Patent Application Publication
(10) Pub. No.: US 2026/0247014 A1
(43) Pub. Date: Aug. 20, 2026

(54) Motion-Triggered Fast Shutter and Readout

(71) Applicant: Google LLC, Mountain View, CA (US)

(72) Inventor: Vickie Youmin Wu, Santa Clara, CA (US)

(73) Assignee: Google LLC, Mountain View, CA (US)

(21) Appl. No.: 19/165,042

(22) PCT Filed: Jun. 5, 2023
(86) PCT No.: PCT/US2023/067935

§ 371 Date: Sep. 12, 2025

(51) Int. Cl. H04N 23/45; H04N 23/68; H04N 25/443; H04N 25/47; H04N 25/772; H04N 25/78

(52) U.S. Cl. CPC H04N 23/45; H04N 23/689; H04N 25/443; H04N 25/47; H04N 25/772; H04N 25/78

(57) ABSTRACT

The present document describes techniques for motion-triggered fast shutter and readout. The techniques described herein reduce motion disparity and rolling shutter effects associated with capturing images of a fast-moving object. Further, these techniques achieve an adaptive system that provides fast shutter speed as needed, minimizes rectifying post processes, and reduces power waste on stationary-like scene areas. In implementations, a camera system includes a pair of synchronized image sensors (e.g., a main sensor and a companion sensor). The companion sensor, running at a higher frame rate and a lower resolution than the main sensor, detects motion and provides motion information (e.g., area of motion and velocity of a moving object) to the main image sensor. The main image sensor uses a dedicated analog-to-digital converter (ADC) circuitry to increase a shutter speed and readout for pixels inside the motion area.

### BACKGROUND

Mobile phones (e.g., smartphones) have become an integral part of many people's daily lives, particularly mobile phones with cameras. A major challenge with such cameras is related to fast motion of camera targets, which cause motion disparity, particularly for cameras using a rolling shutter sensor. Fast motions can be observed from many targets, some examples of which include vehicles, panning hands, running dogs, balls or athletes in sporting events, and so forth. Such fast motions, however, often cause image distortion, such as wobbles, motion blur, and rolling shutter effect, resulting in low-quality images and poor user experiences.

Some attempts to overcome such motion disparity have used small-resolution global shutter sensors (e.g., video graphics array (VGA)). However, such small-resolution global shutter sensors cannot satisfy the requirement of advanced features and high image quality for many existing mobile phone cameras. Another approach is called “slow motion,” which scales down a much larger full frame into a small resolution (e.g., from 4K to 1080P). This scaling down enables the sensors to operate at a much faster shutter speed and a shorter readout time. Further, the image sensor processing (ISP) pipeline can subsequently process images and videos for the “slow-down” moments. However, such scaling down of the frame lowers the image quality, which may be undesirable for high-resolution imaging.

The nature of the rolling shutter sensor and the seemingly ever-increasing resolution of imagery continue to increase the difficulty of applying fast readout and a high-speed frame rate.

### SUMMARY

The present document describes techniques for motion-triggered fast shutter and readout. The techniques described herein reduce motion disparity and the rolling shutter effect associated with capturing images of a fast-moving object. Further, these techniques achieve an adaptive system that provides fast shutter speed as needed, minimizes post-processing rectification, and reduces power waste on stationary-like scene areas. In implementations, a camera system includes a pair of synchronized image sensors (e.g., a main sensor and a companion sensor). The companion sensor, running at a higher frame rate and a lower resolution than the main sensor, detects motion and provides motion information (e.g., area of motion and velocity of moving object) to the main image sensor. Then, the main image sensor uses a dedicated analog-to-digital converter (ADC) circuitry to increase a shutter speed and readout for pixels inside the area of motion.

In aspects, a method for implementing motion-triggered fast shutter and readout is disclosed. The method includes initializing first and second image sensors of an electronic device, where the first and second image sensors share a same field of view and are synchronized together by a microcontroller of the electronic device. The method also includes generating image data using each of the first and second image sensors. In aspects, the second image sensor uses a higher frame rate and a lower resolution than the first image sensor. In addition, the method includes detecting, by the second image sensor, a moving object within the field of view and responsive to detecting the moving object, determining, by the second image sensor, motion information associated with the moving object. In some implementations, the motion information includes a speed of the moving object and a region of interest within the field of view that includes the moving object. The method further includes, based on the motion information determined by the second image sensor, increasing a shutter speed and readout of the first image sensor for the region of interest within the field of view to provide additional image data for the region of interest. Also, the method includes generating an image for display based at least on the image data of the first image sensor and the additional image data of the first image sensor for the region of interest.

In further aspects, a camera device is disclosed. The camera device includes a controller configured to synchronize a plurality of image sensors. The camera device also includes a first image sensor of the plurality of image sensors. In aspects, the first image sensor is configured to capture images. The camera device also includes a second image sensor of the plurality of image sensors. In implementations, the second image sensor has a same field of view as the first image sensor and a smaller resolution than the first image sensor. The controller, the first image sensor, and the second image sensor are configured to collectively perform the above method.

This summary is provided to introduce simplified concepts of motion-triggered fast shutter and readout, which are further described below in the Detailed Description. This summary is not intended to identify essential features of the claimed subject matter.

### BRIEF DESCRIPTION OF THE DRAWINGS

The details of one or more aspects of motion-triggered fast shutter and readout are described in this document with reference to the following drawings. The same numbers are used throughout the drawings to reference like features and components:

FIG. 1 illustrates an example network environment in which aspects of a motion-triggered fast shutter and readout can be implemented;

FIG. 2 illustrates an example implementation of an electronic device from FIG. 1 in more detail;

FIG. 3 illustrates an example top-level diagram of a camera system in FIG. 2, which is configured for motion-triggered fast shutter and readout;

FIG. 4 illustrates an example operation flowchart for motion-triggered fast shutter and readout;

FIG. 5 illustrates an example diagram representing various components of a main image sensor in FIG. 3;

FIG. 6 illustrates an example diagram representing various components of a companion image sensor in FIG. 3;

FIG. 7 illustrates an example environment in which a home area network, as described with reference to FIG. 1, and aspects of a motion-triggered fast shutter and readout can be implemented;

FIG. 8 illustrates an example wireless network device that can be implemented as any of the wireless network devices in a home area network in accordance with one or more aspects of a motion-triggered fast shutter and readout as described herein; and

FIG. 9 illustrates an example system that includes an example device, which can be implemented as any of the wireless network devices that implement aspects of a motion-triggered fast shutter and readout as described with reference to the previous FIGS. 1 to 8.

### DETAILED DESCRIPTION

The present document describes a motion-triggered fast shutter and readout. Rather than addressing motion disparity and rolling shutter effects during post-processing of an image, as many conventional systems do, the techniques described herein address such issues at the origin of pixel capture. In application, a camera system on an electronic device includes a pair of image sensors sharing a common field of view (FOV) and corresponding to lenses with substantially similar effective focal lengths. The pair of image sensors includes a first image sensor (e.g., main image sensor) and a second image sensor (e.g., secondary image sensor, companion image sensor). The main image sensor is a color sensor (e.g., red-green-blue (RGB) image sensor) and can have a relatively high resolution, such as 1080p, 2K, 4K, etc. The companion image sensor, however, is a much smaller resolution sensor that runs at a higher frame rate than the main image sensor. In implementations, the companion image sensor is a monochrome sensor, so it can ignore color and thus have much faster operation compared to the main image sensor. The companion image sensor detects fast motions and moving objects in the shared FOV and provides corresponding motion information to the main image sensor, such as dimensions of a motion area including a moving object and a velocity of the moving object.

The main image sensor receives the motion information, which is configured as register parameters including the motion area and a sample rate, and sets the motion area to a fast shutter speed. Further, the motion area is separated from other operations of the main image sensor. For example, the main image sensor uses a dedicated analog-to-digital converter (ADC) circuitry to sample pixels inside the motion area at a much higher rate than a sample rate used by a regular ADC to sample pixels outside the motion area. Following readout of the pixels, the sampled data from the motion area is sent to a separate on-sensor memory, packetized, and transmitted to a controller.

Thus, computing systems and devices are provided with more efficient methods for reducing rolling shutter effects and motion disparity. Motion-triggered techniques described herein include an adaptive system that provides fast shutter speeds as needed, minimizes post-processing rectification, and reduces power waste on stationary-like scene areas. Accordingly, these disclosed systems and devices increase the effectiveness, efficiency, and user satisfaction with such systems and devices.

While features and concepts of the described techniques for motion-triggered fast shutter and readout can be implemented in any number of different environments, aspects are described in the context of the following examples.

### Example Systems and Apparatuses

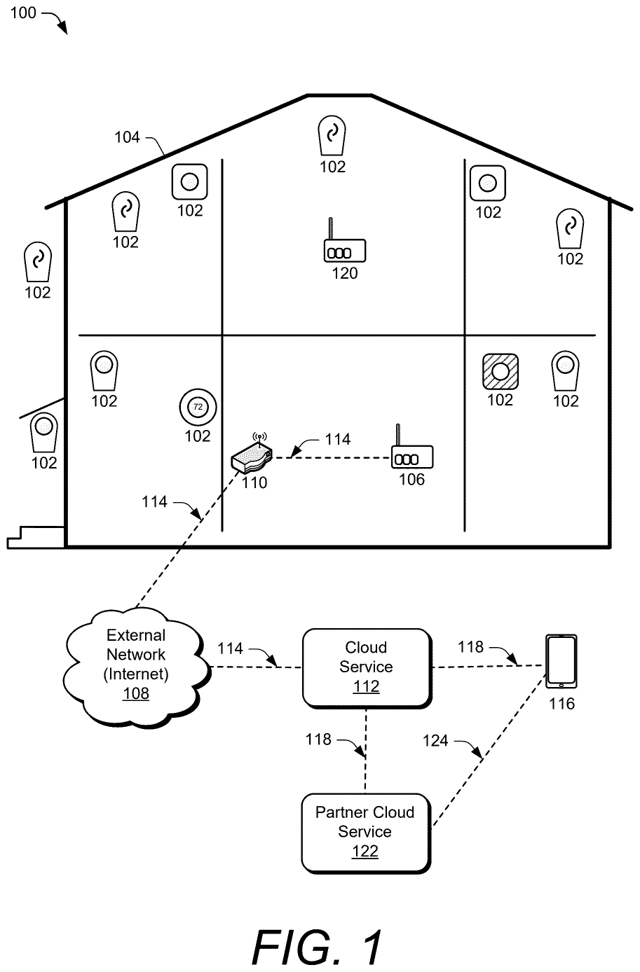

FIG. 1 illustrates an example network environment 100 in which aspects of a motion-triggered fast shutter and readout can be implemented. The network environment 100 includes a home area network (HAN). The HAN includes wireless network devices 102 (e.g., electronic devices) that are disposed about a structure 104, such as a house, and are connected by one or more wireless and/or wired network technologies, as described below. The HAN includes a border router 106 that connects the HAN to an external network 108, such as the Internet, through a home router or access point 110.

To provide user access to functions implemented using the wireless network devices 102 in the HAN, a cloud service 112 connects to the HAN via a border router 106, via a secure tunnel 114 through the external network 108 and the access point 110. The cloud service 112 facilitates communication between the HAN and internet clients 116, such as apps on mobile devices, using a web-based application programming interface (API) 118. The cloud service 112 also manages a home graph that describes connections and relationships between the wireless network devices 102, elements of the structure 104, and users. The cloud service 112 hosts controllers that orchestrate and arbitrate home automation experiences, as described in greater detail below.

The HAN may include one or more wireless network devices 102 that function as a hub 120. The hub 120 may be a general-purpose home automation hub, or an application-specific hub, such as a security hub, an energy management hub, a heating, ventilation, and air conditioning (HVAC) hub, and so forth. The functionality of the hub 120 may also be integrated into any wireless network device 102, such as a smart thermostat device or the border router 106. In addition to hosting controllers on the cloud service 112, controllers can be hosted on any hub 120 in the structure 104, such as the border router 106. A controller hosted on the cloud service 112 can be moved dynamically to the hub 120 in the structure 104, such as moving an HVAC zone controller to a newly installed smart thermostat.

Hosting functionality on the hub 120 in the structure 104 can improve reliability when the user's internet connection is unreliable, can reduce latency of operations that would normally have to connect to the cloud service 112, and can satisfy system and regulatory constraints around local access between the wireless network devices 102.

The wireless network devices 102 in the HAN may be from a single manufacturer that provides the cloud service 112 as well, or the HAN may include wireless network devices 102 from partners. These partners may also provide partner cloud services 122 that provide services related to their wireless network devices 102 through a partner Web API 124. The partner cloud services 122 may optionally or additionally provide services to the internet clients 116 via the web-based API 118, the cloud service 112, and the secure tunnel 114.

The network environment 100 can be implemented on a variety of hosts, such as battery-powered microcontroller-based devices, line-powered devices, and servers that host cloud services. Protocols operating in the wireless network devices 102 and the cloud service 112 provide a number of services that support operations of home automation experiences in the distributed computing environment 100. These services include, but are not limited to, real-time distributed data management and subscriptions, command-and-response control, real-time event notification, historical data logging and preservation, cryptographically controlled security groups, time synchronization, network and service pairing, and software updates.

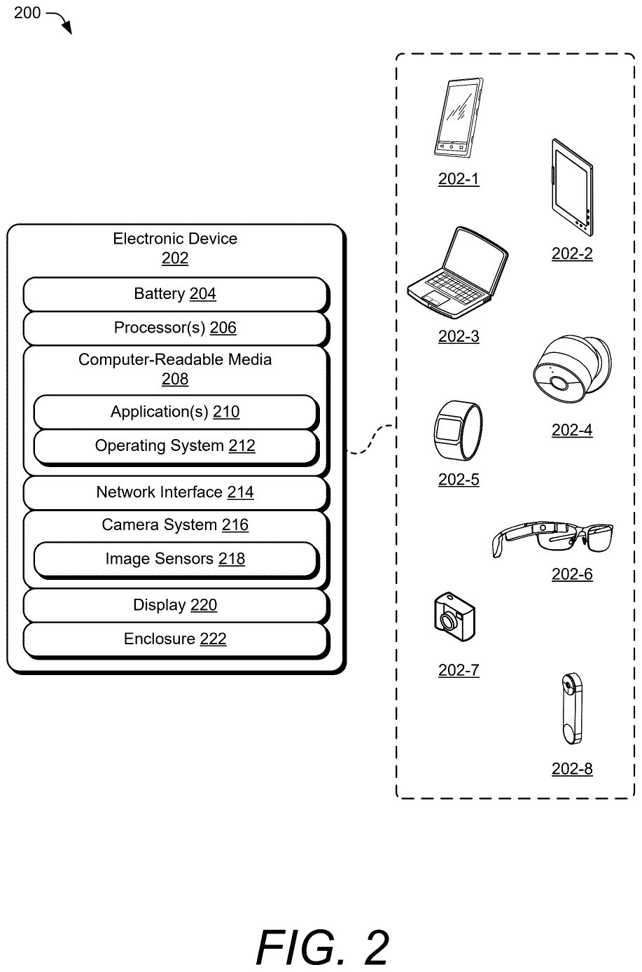

FIG. 2 illustrates an example implementation of an electronic device from FIG. 1 in more detail. An electronic device 202 (e.g., the wireless network device 102, mobile device) of FIG. 2 is illustrated with a variety of example devices, including a smartphone 202-1, a tablet 202-2, a laptop 202-3, a security camera 202-4, a computing watch 202-5, computing spectacles 202-6, a digital camera 202-7, and a video-recording doorbell 202-8. The electronic device 202 can also include other devices, such as televisions, entertainment systems, desktop computers, audio systems, projectors, automobiles, drones, track pads, drawing pads, netbooks, e-readers, home security systems, camera systems, thermostats, and other home appliances. Note that the electronic device 202 can be mobile, wearable, non-wearable but mobile, or relatively immobile (e.g., desktops and appliances).

The electronic device 202 includes a battery pack (e.g., battery 204). The battery 204 may be any suitable battery, rechargeable or non-rechargeable. As described herein, the battery 204 may be a Li-ion battery.

The electronic device 202 includes one or more processors 206 (e.g., any of microprocessors, microcontrollers, or other controllers) that can process various computer-executable instructions to control operation of the electronic device 202 and to enable techniques for a motion-triggered fast shutter and readout. The processors 206 are described in further detail below.

The electronic device 202 also includes computer-readable media 208 (CRM 208) that provides storage for various applications 210 and system data. Applications 210 and/or an operating system 212 implemented as computer-readable instructions on the computer-readable media 208 (e.g., the storage media) can be executed by the processor(s) 206 to provide some or all of the functionalities described herein. The computer-readable media 208 provides data storage mechanisms to store various device applications 210, the operating system 212, memory/storage, and other types of information and/or data related to operational aspects of the electronic device 202. For example, the operating system 212 can be maintained as a computer application within the computer-readable media 208 and executed by the processor(s) 206 to provide some or all of the functionalities described herein. The device applications 210 may include a device manager, such as any form of a control application, a software application, or signal-processing and control modules. The electronic device 202 may also include, or have access to, one or more machine learning systems.

Various implementations of the application(s) 210 can include, or communicate with, a system-on-chip (SoC), one or more integrated circuits (ICs), a processor having embedded processor instructions or configured to access processor instructions stored in memory, hardware with embedded firmware, a printed circuit board (PCB) with various hardware components, or any combination thereof. The PCB may be formed, for example, from glass-reinforced epoxy material such as FR4. In some instances, the PCB may include a single layer of electrically conductive traces and be a single-layer board. In other instances, the PCB may be a multi-layer board that includes multiple layers of electrically conductive traces that are separated by layers of a dielectric material.

The electronic device 202 may also include a network interface 214. The electronic device 202 can use the network interface 214 for communicating data over wired, wireless, optical, or audio (e.g., acoustic) networks. By way of example and not limitation, the network interface 214 may communicate data over a local-area network (LAN), a wireless local-area network (WLAN), a HAN, a personal-area network (PAN), a wide-area network (WAN), an intranet, the Internet, a peer-to-peer network, point-to-point network, or a mesh network. The network interface 214 can be implemented as one or more of a serial and/or parallel interface, a wireless interface, any type of network interface, a modem, or any other type of communication interface. Using the network interface 214, the electronic device 202 may communicate via a cloud computing service (e.g., the cloud service 112) to access a platform having resources.

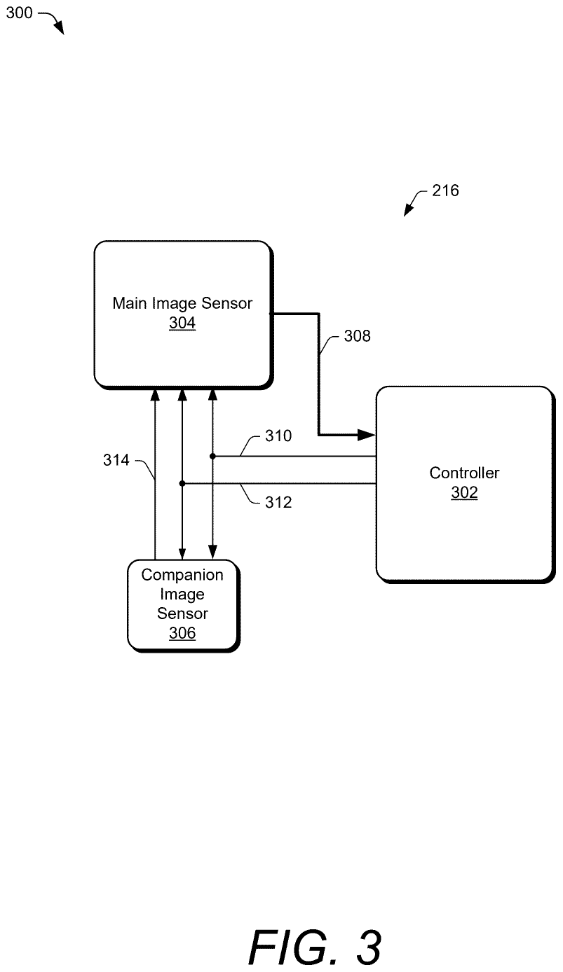

The electronic device 202 also includes a camera system 216. The camera system 216 is configured to capture images, video, and/or audio. Any suitable camera system 216 may be implemented in or communicatively coupled to the electronic device 202. The camera system 216 may be a digital camera that converts light captured by a lens to digital data representing a scene within an FOV of the lens. In implementations, the camera system 216 includes multiple image sensors 218, including at least a main image sensor and a companion image sensor. As described herein, the main image sensor may be a color sensor and the companion image sensor may be a monochrome sensor that has a lower resolution but a higher frame rate than the main image sensor. Further details of the image sensors 218 are described with respect to FIGS. 3-6.

The electronic device 202 can also include a display 220 (e.g., display device 220). The display 220 can include any suitable touch-sensitive display device, such as a touchscreen, a liquid crystal display (LCD), a thin-film transistor (TFT) LCD, an in-place switching (IPS) LCD, a capacitive touchscreen display, an organic light-emitting diode (OLED) display, an active-matrix organic light-emitting diode (AMOLED) display, a super AMOLED display, and so forth. The display 220 may be referred to as a display or a screen, such that digital content may be displayed on-screen.

The electronic device 202 also includes an enclosure 222 (e.g., housing). The enclosure 222 houses the various components of the electronic device 202, including, for example, the battery 204 and the camera system 216. In aspects, the enclosure 222 includes at least two portions that are coupled together. The at least two portions of the enclosure 222 can be tightly fitted together with seals to prevent dust and water ingress into circuitry and other components housed within the enclosure 222.

These and other capabilities and configurations, as well as ways in which entities of FIGS. 1 and 2 act and interact, are set forth in greater detail below. These entities may be further divided, combined, and so on. The network environment 100 of FIG. 1 and the detailed illustrations of FIG. 2 through FIG. 9 illustrate some of many possible environments, devices, and methods capable of employing the described techniques, whether individually or in combination with one another. FIGS. 3 to 9 illustrate various implementations of a motion-triggered fast shutter and readout and are not necessarily limited to the combinations shown for implementing the motion-triggered fast shutter and readout. These implementations may be further divided, combined, reorganized, or linked to provide a wide array of additional and/or alternate implementations.

FIG. 3 illustrates an example top-level diagram 300 of the camera system 216 in FIG. 2, which is configured for motion-triggered fast shutter and readout. The illustrated example includes a controller 302, a main image sensor 304, and a companion image sensor 306. The controller 302 provides computing functionality for the camera system 216 of the electronic device 202. The controller 302 is master to both the main image sensor 304 and the companion image sensor 306. The controller 302 (e.g., microcontroller) can include any suitable controller device, some examples of which include an SoC, an in-system programming (ISP) device, a central processing unit (CPU), a memory, an application-specific integrated circuit (ASIC), a tensor processing unit (TPU), etc.

The main image sensor 304 (e.g., the image sensor 218 in FIG. 2) provides a primary image input to the camera system 216 via the controller 302. For example, the main image sensor 304 generates pixel data or images and provides the pixel data or images to the controller 302 via a first communication interface 308, such as a Mobile Industry Processor Interface Alliance (MIPI) interface. The main image sensor 304 may be a primary camera for the camera system 216. For example, the main image sensor 304 can be a full color (e.g., RGB image sensor. Further, the main image sensor 304 can be configured for any suitable image size, such as 20 megapixels (MP), 35 MP, 54 MP, 96 MP, 140 MP, 200 MP, and so on. Generally, the main image sensor 304, in a normal mode, operates at a fixed frame rate, has one shutter speed for its entire pixel array, and reads out an image using a raster scan order from top to bottom and left to right.

The companion image sensor 306 (e.g., the image sensor 218 in FIG. 2) is an assistant camera that supports the functionality of the main image sensor 304 for motion-triggered fast shutter and readout. In aspects, the companion image sensor 306 has a same FOV as the main image sensor 304. The two image sensors 304 and 306 also correspond to lenses with a same effective focal length. Further, the companion image sensor 306 has a lower resolution than the main image sensor 304 and operates at a higher frame rate than the main image sensor 304. In some implementations, the companion image sensor 306 is a monochrome image sensor. The companion image sensor 306 is a relatively small image sensor, such as a video graphics array (VGA) sensor (640×480 pixels), a 400×100 pixel sensor, a 600×400 pixel sensor, and so forth. In implementations, the companion image sensor 306 includes a small intelligent engine, such as a microcontroller configured to run a logic block for detecting fast motion. For example, the companion image sensor 306 can include an embedded object-tracking algorithm, such as a sparse Kanade-Lucas-Tomasi (KLT) feature tracker, used to generate coarse motion information about a moving object, including size, speed, direction, and so forth. In operation, the companion image sensor 306 acts as a monitor to detect fast motions and moving objects in the FOV. For example, the companion image sensor 306 detects an area within the FOV of the companion image sensor 306 that includes the moving object. The companion image sensor 306 can also determine the speed and direction of the moving object. The motion information is then provided to the main image sensor 304 to enable the main image sensor 304 to adjust its image capture for the moving object.

The controller 302 uses a synchronization interface (e.g., Vsync 310) to synchronize the main image sensor 304 and the companion image sensor 306. In addition, the controller 302 uses a first communication link 312 (e.g., control interface) to control both the main image sensor 304 and the companion image sensor 306. The first communication link 312 can be any suitable control interface for controlling the image sensors 304 and 306, some examples of which include I2C protocol, I3C protocol, and so forth.

A second communication link 314 (e.g., control interface) is used by the companion image sensor 306 to communicate with the main image sensor 304. The second communication link 314 can be any suitable communication link, including I2C protocol, I3C protocol, and so forth. In an example, after the companion image sensor 306 detects motion in the FOV and determines an area within the FOV that includes or bounds the subject of the motion (e.g., moving object) as well as the relative speed of the moving object, the companion image sensor 306 transmits information (e.g., motion information) associated with the area, speed, and/or direction of the moving object to the main image sensor 304 via the second communication link 314. In aspects, the area that includes the moving object can be referred to as a “motion area.” The transmitted information can include register parameters including the determined motion area and a sample rate for the main image sensor 304 to use on the motion area. Note that the second communication link 314 is illustrated as being unidirectional from the companion image sensor 306 to the main image sensor 304. In such an implementation, the main image sensor 304 does not provide feedback to the companion image sensor 306. Rather, the signals provided by the companion image sensor 306 to the main image sensor 304 via the second communication link 314 are used to program the main image sensor 304 relative to the moving object.

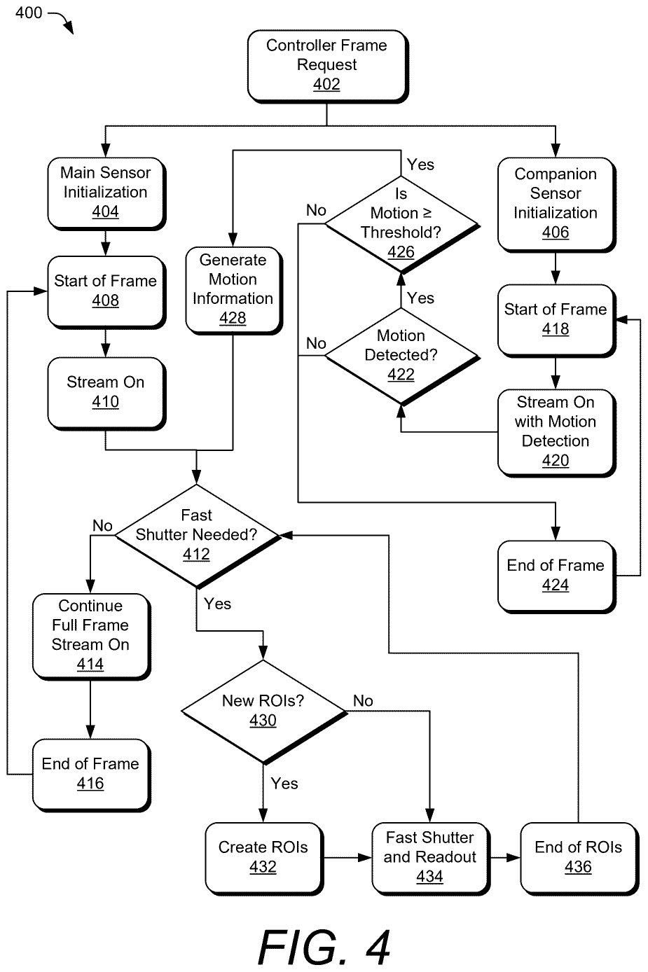

FIG. 4 illustrates an example operation flowchart 400 for motion-triggered fast shutter and readout. The operation flowchart 400 can be performed by the electronic device 202, in particular the camera system 216 in FIG. 3. The flowchart 400 is shown as a set of blocks that specify operations performed but are not necessarily limited to the order or combinations shown for performing the operations by the respective blocks. Further, any of one or more of the operations may be repeated, combined, reorganized, or linked to provide a wide array of additional and/or alternate methods. In portions of the following discussion, reference may be made to the example implementations, environments, entities, and/or processes as detailed in FIGS. 1-3, reference to which is made for example only. The techniques are not limited to performance by one entity or multiple entities operating on one device.

A controller (e.g., the controller 302 in FIG. 3) may remain in an idle mode until it receives a request to initialize camera operation. The controller receives a frame request 402 to initialize camera operation. The frame request 402 may be triggered via a user interface of the electronic device 202, such as by a user input received via an application running on the electronic device 202 or some operation at an operating system (OS) level. So, the frame request 402 can be user input-based or kernel-based. Based on the frame request 402, the controller 302 transmits control signals to both the main image sensor 304 and the companion image sensor 306 to initially program and synchronize both image sensors 304 and 306. Main sensor initialization 404 includes initializing a setup, a camera resolution, a frame speed, an exposure time, an operating mode, etc. of the main image sensor 304. Similarly, companion sensor initialization 406 includes initializing a setup, a camera resolution, a frame speed, an exposure time, gains, an operating mode, etc., of the companion image sensor 306. Both image sensors 304 and 306 can run in snapshot mode or video mode. In one example, the main image sensor 304 can be set to run in 4K mode, 2K mode, 1080p mode, etc. Also, the companion image sensor 306 can be set to run in a lower resolution mode than the main image sensor 304, such as 1080p mode, 720p mode, 480p mode, etc.

After setup, the main image sensor 304 begins generating image data (e.g., start of frame 408) and then streaming (e.g., stream on 410) the image data for an entire image frame (“full frame”). For example, the main image sensor 304 transmits the image data to the controller 302 via the first communication interface 308 (e.g., MIPI interface). Then, the main image sensor 304 determines if a fast shutter is needed 412. If there is no input from the companion image sensor 306, then the main image sensor 304 determines that no fast shutter is needed (“NO” at 412) and, at 414, continues streaming the image data for the full frame and completes the frame capture (e.g., end of frame 416). The main image sensor 304 then returns to the start of frame 408 to capture another frame of image data and continues this feedback loop until reaching a different result at 412.

After setup of the companion image sensor 306 (substantially synchronously with the main image sensor 304), the companion image sensor 306 begins generating its own image data (e.g., start of frame 418) and, at 420, streams the image data, at a lower resolution and higher frame rate, with motion detection active. At 422, the companion image sensor 306 determines if motion is detected. If no motion is detected (“NO” at 422), the companion image sensor 306 completes the image capture (e.g., end of frame 424) and returns to the start of frame 418 to capture another frame of image data and continue this feedback loop.

If motion is detected (“YES” at 422), then at 426 the companion image sensor 306 determines if the motion is equal to or greater than a threshold value. For example, the companion image sensor 306 can determine if the speed of the moving object is greater than a threshold speed (e.g., 1.0 feet per second (ft/s), 2.0 ft/s, 2.5 ft/s). In this way, if a slow-moving object is detected, then a fast shutter may not be needed to avoid a rolling shutter effect. Velocity may be used instead of speed to include the direction of the motion. Alternatively or in addition, the companion image sensor 306 can determine if the size of the moving object is greater than a threshold size, which can be relative to the frame and/or include a certain number of pixels. The threshold size can be any suitable size relative to the frame, including, for example, 1/10 of the frame size, 1/50 of the frame size, 1/100 of the frame size, etc. In this way, if the moving object is substantially small, then the moving object may be determined to be insignificant to the image and/or unimportant to a user. If the detected motion (e.g., size, velocity) is not equal to or greater than the threshold value (“NO” at 426), then the companion image sensor 306 completes the image capture (e.g., end of frame 424) and returns to the start of frame 418 to capture another frame of image data and continue the feedback loop. If, however, the detected motion is equal to or greater than the threshold value (“YES” at 426), then at 428 the companion image sensor 306 generates motion information and sends the motion information to the main image sensor 304. In some aspects, multiple moving objects can be detected and motion information can be generated for each moving object individually.

If the main image sensor 304 determines, based on the motion information, that a fast shutter is needed for the moving object(s) (“YES” at 412), then the main image sensor 304 determines, at 430, if one or more new regions of interest (ROIs) are needed for the moving object(s). This determination is based on the dimensions (e.g., width, height) and location (e.g., (x, y) coordinates) of the motion area within the frame, as indicated in the motion information. If an ROI is new (“YES” at 430), then at 432 the main image sensor 304 creates a program for the new area(s) (e.g., ROIs) and increases shutter speed for the new ROI(s) by executing a fast shutter and readout 434 mode on the new ROI(s). In aspects, the fast shutter and readout 434 may be a mode that implements a shutter speed that is faster than a normal shutter speed used for the entire frame. In some implementations, the fast shutter and readout 434 mode may be a mode that implements a fastest possible shutter speed of the main image sensor 304. The main image sensor 304 then completes a readout (e.g., end of ROIs 436) for the new ROIs and loops back to 412 to continue this feedback loop. If, however, the main image sensor 304 determines that an ROI currently exists (“NO” at 430), then the main image sensor 304 can continue operating on the current ROI and increase the shutter speed for the current ROI by executing the fast shutter and readout 434 mode on the current ROI.

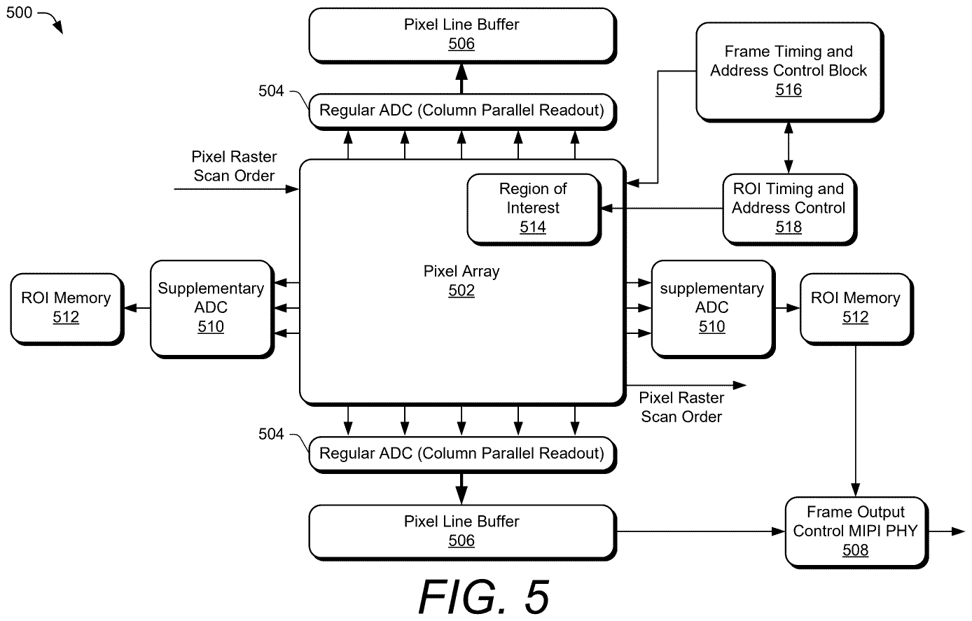

FIG. 5 illustrates an example diagram 500 representing various components of the main image sensor 304 in FIG. 3. The various components of the main image sensor 304 can be used to perform portions of the operation flowchart 400 in FIG. 4 for motion-triggered fast shutter and readout. The main image sensor 304 includes a pixel array 502 used to capture photons and generate analog signals (e.g., voltage) for each pixel through the use of capacitors and amplifiers. The analog signals are passed to one or more ADCs, which convert the analog signals into digital signals. In the illustrated example, the main image sensor 304 includes two regular ADCs 504, each of which is configured for column parallel readout. Each regular ADC 504 reads out entire lines of pixel array data parallelly and provides the pixel array data to a pixel line buffer 506. The pixel array data in the pixel line buffer(s) 506 is passed to a frame output control interface 508, which may be a physical MIPI interface. In aspects, information passed to the frame output control interface 508 includes a rate change, a MIPI protocol, and packaging. Such information is transmitted through another MIPI interface from the frame output control interface 508 to serialize the pixel array data and pass it to the controller 302 (in FIG. 3).

The main image sensor 304 also includes one or more additional ADCs (e.g., supplementary ADCs 510) or sets of ADCs, each ADC being connected to an ROI memory 512. The supplementary ADCs 510 are used for collecting pixel array data in a particular region of the pixel array 502, such as an ROI 514 that is determined to include motion or a moving object. A supplementary ADC 510 is used to read out the ROI 514 separately from the rest of the pixel array 502. Different supplementary ADCs 510 can be used to read out different ROIs 514. Depending on a size of the ROI 514, the supplementary ADC 510 can essentially mimic a global shutter for the ROI 514.

When motion is detected and an ROI is determined, a frame timing and address control block 516 controls timing and addresses separately from the rest of the pixel array 502. In the illustrated example, one ROI is detected (e.g., ROI 514) and an ROI timing and address control block 518 programs the ROI 514 as an area for special treatment, such as global shutter or fast motion shutter and readout.

In aspects, the main image sensor 304 uses a regular raster scan order from top to bottom and left to right. However, the raster scan order can be divided into multiple sets of address pointers. For example, when the companion image sensor 306 detects motion, it sends a request or interrupt to the main image sensor 304 along with the dimensions and location of the ROI 514 (translated into a corresponding area (e.g., ROI 514) of the pixel array 502 of the main image sensor 304). The location may include (x, y) coordinate boundaries. The ROI 514 is set to a new shutter speed. For example, pixels inside the ROI 514 are integrated and sampled independently at a much higher rate than pixels outside the ROI 514. The sample rate is correlated with a velocity detected by the companion image sensor 306, which may be greater than a “normal” 30/60 frames per second (fps) frame rate. To serve the ROI 514 faster, a dedicated ADC circuitry (e.g., the supplementary ADC 510) is used to avoid collisions with normal sensor operation, such as operations by the regular ADCs 504. Following the readout, the sampled data from the ROI 514 is sent to a separate on-sensor memory, such as static random access memory (SRAM) (e.g., ROI memory 512) of the main image sensor 304, and packetized with virtual identifiers (IDs) and metadata (e.g., by the frame output control interface 508) to provide packetized data. The packetized data is then transmitted to the controller 302 over one or more communication interfaces (e.g., MIPI channels, virtual channel, the first communication interface 308 in FIG. 3).

If the ROI 514 is ahead of a current pixel register, the main image sensor 304 can separate out the ROI 514 using another set of registers that specifically serve that ROI 514. The supplementary ADC 510 reads out the ROI 514 while the regular ADCs 504 continue normal readout of the entire pixel array 502. If the current pixel register is in the middle of the ROI 514, a frame buffer (not shown in FIG. 4) can abort or restart an area. Alternatively, the frame buffer can complete the frame and separate out the ROI 514 when beginning a new frame. In some implementations, the ROI 514 can be set to a maximum shutter speed of the main image sensor 304. Also, additional ROIs 514 can be used to track additional moving objects. Further, one ROI 514 or a combination of overlapping ROIs 514 can be used to track multiple objects within a threshold (e.g., distance, number of pixels) of each other. In some aspects, to reduce complications in design, control, and implementation, the ROI(s) 514 can be used to track only a subset (e.g., 2, 3, 4) of a large group (e.g., 5 or more) of moving objects, such as by tracking only a few dominant moving objects of the group.

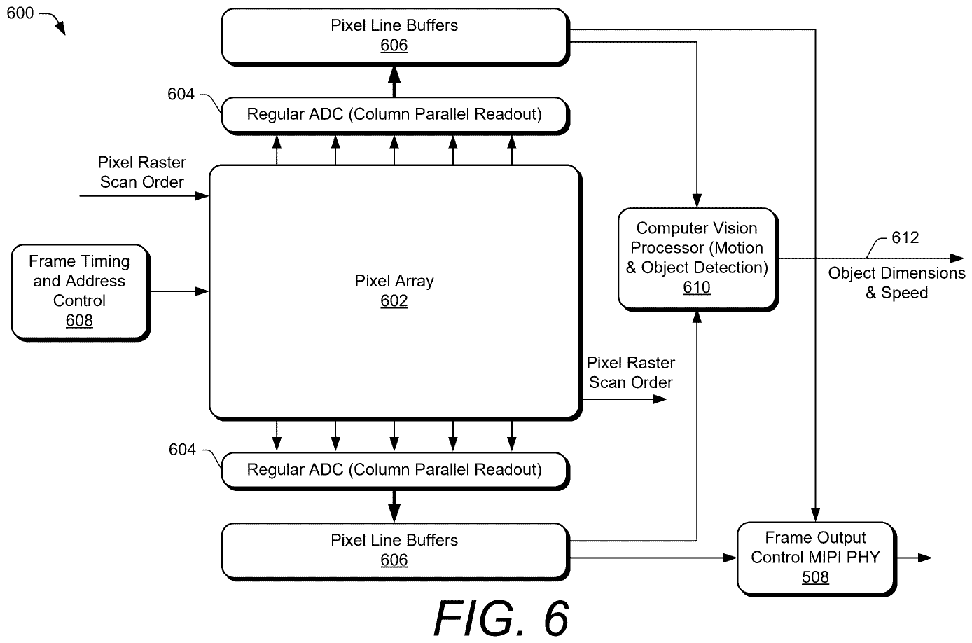

FIG. 6 illustrates an example diagram 600 representing various components of the companion image sensor 306 in FIG. 3. The various components of the companion image sensor 306 can be used to perform portions of the operation flowchart 400 in FIG. 4 for motion-triggered fast shutter and readout. The companion image sensor 306 includes a pixel array 602 and a set of regular ADCs 604, which are configured for column parallel readout. The regular ADCs 604 convert analog signals from the pixel array 602 into digital signals and provide pixel array data in the form of digital signals to pixel line buffers 606. The companion image sensor 306 also includes a frame timing and address control block 608 for controlling timing and addresses of the signals from the pixel array 602. In addition, the companion image sensor 306 includes a computer vision processor 610, such as a microcontroller, having motion and object detection capabilities. The computer vision processor 610 can run an object-tracking algorithm to generate motion information about a detected moving object. As described, the motion information can include object dimensions and speed 612 (or velocity) of the moving object. The object dimensions can be a closed, two-dimensional shape that bounds the moving object. The shape can be any arbitrary shape that encloses the moving object, including for example, a polygon (including a rectangle, a square, or a trapezoid), an ellipse, and so on. Due to differences in resolution, the companion image sensor 306 may translate the motion information to scale the object dimensions from the lower resolution of the companion image sensor 306 to a corresponding area (e.g., ROI 514) for the pixel array 502 of the main image sensor 304 (shown in FIG. 5) and at the higher resolution of the main image sensor 304.

These and other capabilities and configurations, as well as ways in which entities of FIG. 1 through 2 act and interact, are set forth in greater detail below. The entities described with respect to FIG. 1 through FIG. 9 may be further divided, combined, and so on. The environment 100 of FIG. 1, and the detailed illustrations of FIG. 2 through FIG. 9, illustrate some of many possible environments, devices, and methods capable of employing the described techniques, whether individually or in combination with one another.

### Example Environments and Devices

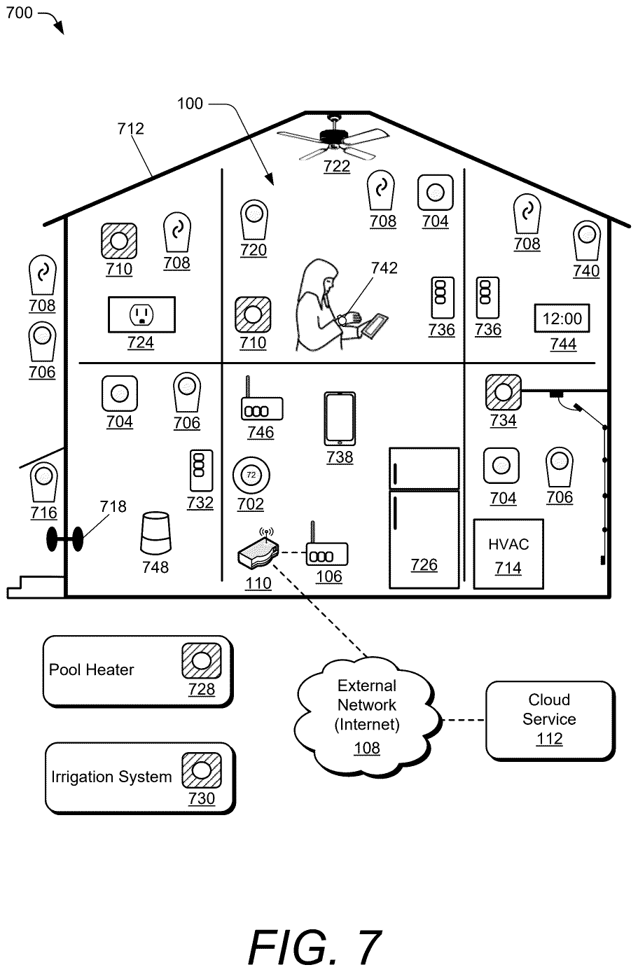

FIG. 7 illustrates an example environment 700 in which a HAN, as described with reference to FIG. 1, and aspects of a motion-triggered fast shutter and readout can be implemented. Generally, the environment 700 includes the HAN implemented as part of a home or another type of structure with any number of wireless network devices (e.g., wireless network devices 102) that are configured for communication in a wireless network. For example, the wireless network devices can include a thermostat 702, hazard detectors 704 (e.g., for smoke and/or carbon monoxide), cameras 706 (e.g., indoor and outdoor), lighting units 708 (e.g., indoor and outdoor), and any other types of wireless network devices 710 that are implemented inside and/or outside of a structure 712 (e.g., in a home environment). In this example, the wireless network devices can also include any of the previously described devices, such as a border router 106, as well as the electronic device 202.

In the environment 700, any number of the wireless network devices can be implemented for wireless interconnection to wirelessly communicate and interact with each other. The wireless network devices are modular, intelligent, multi-sensing, network-connected devices that can integrate seamlessly with each other and/or with a central server or a cloud-computing system to provide any of a variety of useful automation objectives and implementations. An example of a wireless network device that can be implemented as any of the devices described herein is shown and described with reference to FIG. 7.

In implementations, the thermostat 702 may include a Nest® Learning Thermostat that detects ambient climate characteristics (e.g., temperature and/or humidity) and controls an HVAC system 714 in the home environment. The learning thermostat 702 and other network-connected devices “learn” by capturing occupant settings to the devices. For example, the thermostat 702 learns preferred temperature set points for mornings and evenings and when occupants of the structure are asleep or awake, as well as when the occupants are typically away or at home.

A hazard detector 704 can be implemented to detect a presence of a hazardous substance or a substance indicative of a hazardous substance (e.g., smoke, fire, or carbon monoxide). In examples of wireless interconnection, a hazard detector 704 may detect a presence of smoke, indicating a fire in the structure, in which case the hazard detector 704 that first detects the smoke can broadcast a low-power wake-up signal to all of the connected wireless network devices. Other hazard detectors 704 can then receive the broadcast wake-up signal and initiate a high-power state for hazard detection and to receive wireless communications of alert messages. Further, the lighting units 708 can receive the broadcast wake-up signal and activate in a region of the detected hazard to illuminate and identify a problem area. In another example, the lighting units 708 may activate in one illumination color to indicate a problem area or region in the structure, such as for a detected fire or break-in, and activate in a different illumination color to indicate safe regions and/or escape routes out of the structure.

In various configurations, the wireless network devices 710 can include an entryway interface device 716 that functions in coordination with a network-connected door lock system 718 and that detects and responds to a person's approach to or departure from a location, such as an outer door of the structure 712. The entryway interface device 716 can interact with the other wireless network devices based on whether someone has approached or entered the home environment. The entryway interface device 716 can control doorbell functionality, announce an approach or departure of a person via audio or visual means, and control settings on a security system, such as to activate or deactivate the security system when occupants come and go. The wireless network devices 710 can also include other sensors and detectors, such as to detect ambient lighting conditions, detect room-occupancy states (e.g., with an occupancy sensor 720), and control a power and/or dim state of one or more lights. In some instances, the sensors and/or detectors may also control a power state or speed of a fan, such as a ceiling fan 722. Further, the sensors and/or detectors may detect occupancy in a room or enclosure and control a supply of power to electrical outlets or devices 724, such as if the room or the structure is unoccupied.

The wireless network devices 710 may also include connected appliances and/or controlled systems 726, such as refrigerators, stoves and ovens, washers, dryers, air conditioners, pool heaters 728, irrigation systems 730, security systems 732, and so forth, as well as other electronic and computing devices, such as televisions, entertainment systems, computers, intercom systems, garage-door openers 734, ceiling fans 722, control panels 736, and the like. When plugged in, an appliance, device, or system can announce itself to the HAN as described above and can be automatically integrated with controls and devices of the HAN, such as in the home. It should be noted that the wireless network devices 710 may include devices physically located outside of the structure but within wireless communication range, such as a device controlling a swimming pool heater 728 or an irrigation system 730.

As described above, the HAN includes a border router 106 that interfaces for communication with an external network outside the HAN. The border router 106 connects to an access point 110, which connects to an external network 108, such as the Internet. A cloud service 112, which is connected via the external network 108, provides services related to and/or using the devices within the HAN. By way of example, the cloud service 112 can include applications for connecting end-user devices 738, such as smartphones, tablets, and the like, to devices in the HAN, processing and presenting data acquired in the HAN to end-users, linking devices in one or more HANs to user accounts of the cloud service 112, provisioning and updating devices in the HAN, and so forth. For example, a user can control the thermostat 702 and other wireless network devices in the home environment using a network-connected computer or portable device, such as a mobile phone or tablet device. Further, the wireless network devices can communicate information to any central server or cloud-computing system via the border router 106 and the access point 110. The data communications can be conducted using any of a variety of custom or standard wireless protocols (e.g., Wi-Fi, ZigBee for low power, 6LoWPAN, Thread, etc.) and/or by using any of a variety of custom or standard wired protocols (CAT6 Ethernet, HomePlug, and so on).

Any of the wireless network devices in the HAN can serve as low-power and communication nodes to create the HAN in the home environment. Individual low-power nodes of the network can regularly send out messages regarding what they are sensing, and other low-power nodes in the environment—in addition to sending out their own messages—can repeat the messages, thereby communicating the messages from node to node (e.g., from device to device) throughout the HAN. The wireless network devices can be implemented to conserve power, particularly when battery-powered, by utilizing low-powered communication protocols to receive the messages, translate the messages to other communication protocols, and send the translated messages to other nodes and/or to a central server or cloud-computing system. For example, the occupancy sensor 720 and/or an ambient light sensor 740 can detect an occupant in a room as well as measure ambient light and activate a light source when the ambient light sensor 740 detects that the room is dark and when the occupancy sensor 720 detects that someone is in the room. Further, the sensors 720 and 740 can include a low-power wireless communication chip (e.g., an IEEE 802.15.4 chip, a Thread chip, a ZigBee chip) that regularly sends out messages regarding an occupancy of the room and an amount of light in the room, including instantaneous messages coincident with the occupancy sensor 720 detecting a presence of a person in the room. As mentioned above, these messages may be sent wirelessly, using the HAN, from node to node (e.g., network-connected device to network-connected device) within the home environment as well as over the Internet to a central server or cloud-computing system.

In other configurations, various ones of the wireless network devices can function as “tripwires” for an alarm system in the home environment. For example, in the event a perpetrator circumvents detection by alarm sensors located at windows, doors, and other entry points of the structure or environment, an alarm could still be triggered by receiving an occupancy, motion, heat, sound, etc. message from one or more of the low-powered mesh nodes in the HAN. In other implementations, the HAN can be used to automatically turn on and off the lighting units 708 as a person transitions from room to room in the structure. For example, the wireless network devices can detect the person's movement through the structure and communicate corresponding messages via the nodes of the HAN. Using the messages that indicate which rooms are occupied, other wireless network devices that receive the messages can activate and/or deactivate accordingly. As referred to above, the HAN can also be utilized to provide exit lighting in the event of an emergency, such as by turning on appropriate lighting units 708 that lead to a safe exit. The lighting units 708 may also be turned on to indicate a direction along an exit route that a person should travel to safely exit the structure.

The various wireless network devices may also be implemented to integrate and communicate with wearable computing devices 742, such as may be used to identify and locate an occupant of the structure and adjust a temperature, lighting, sound system, and the like accordingly. In other implementations, radio-frequency identification (RFID) sensing (e.g., a person having an RFID bracelet, necklace, or key fob), synthetic vision techniques (e.g., video cameras and face recognition processors), audio techniques (e.g., voice, sound pattern, vibration pattern recognition), ultrasound sensing/imaging techniques, and infrared or near-field communication (NFC) techniques (e.g., a person wearing an infrared or NFC-capable smartphone), along with rules-based inference engines or artificial intelligence techniques, may draw useful conclusions from sensed information as to a location of an occupant in the structure or environment.

In other implementations, personal comfort-area networks, personal health-area networks, personal safety-area networks, and/or other such human-facing functionalities of service robots can be enhanced by logical integration with other wireless network devices and sensors in the environment according to rules-based inferencing techniques or artificial intelligence techniques for achieving better performance of these functionalities. In an example relating to a personal health area, the wireless network devices can detect whether a household pet is moving toward a current location of an occupant (e.g., using any of the wireless network devices and sensors), along with rules-based inferencing and artificial intelligence techniques. Similarly, a hazard detector service robot can be notified that the temperature and humidity levels are rising in a kitchen and temporarily raise a hazard detection threshold, such as a smoke detection threshold, under an inference that any small increases in ambient smoke levels will most likely be due to cooking activity and not due to a genuinely hazardous condition. Any service robot that is configured for any type of monitoring, detecting, and/or servicing can be implemented as a mesh node device on the HAN, conforming to wireless interconnection protocols for communicating on the HAN.

The wireless network devices 710 may also include a network-connected alarm clock 744 for each of the individual occupants of the structure in the home environment. For example, an occupant can customize and set an alarm device for a wake time, such as for the next day or week. Artificial intelligence can be used to consider occupant responses to the alarms when they go off and make inferences about preferred sleep patterns over time. An individual occupant can then be tracked in the HAN based on a unique signature of the person, which is determined based on data obtained from sensors located in the wireless network devices, such as ultrasonic sensors, passive IR sensors, and the like. The unique signature of the occupant can be based on a combination of patterns of movement, voice, height, size, etc., as well as using facial or audio recognition techniques.

In an example of wireless interconnection, the wake time for an individual can be associated with the thermostat 702 to control the HVAC system 714 in an efficient manner so as to pre-heat or cool the structure to desired sleeping and awake temperature settings. The preferred settings can be learned over time, such as by capturing temperatures set in the thermostat 702 before the person goes to sleep and upon waking up. Collected data may also include biometric indications of a person, such as breathing patterns, heart rate, movement, etc., from which inferences are made based on this data in combination with data that indicates when the person actually wakes up. Other wireless network devices can use the data to provide other automation objectives, such as adjusting the thermostat 702 so as to pre-heat or cool the environment to a desired setting and turning on or turning off the lighting units 708.

In implementations, the wireless network devices can also be utilized for sound, vibration, and/or motion sensing, such as to detect running water and determine inferences about water usage in a home environment based on algorithms and mapping of the water usage and consumption. This can be used to determine a signature or fingerprint of each water source in the home and is also referred to as “audio fingerprinting water usage.” Similarly, the wireless network devices can be utilized to detect a subtle sound, vibration, and/or motion of unwanted pests, such as mice and other rodents, as well as termites, cockroaches, and other insects. The wireless network devices can then notify an occupant of the suspected pests in the environment, such as with warning messages to help facilitate early detection and prevention.

The environment 700 may include one or more wireless network devices that function as a hub 746. The hub 746 (e.g., hub 120) may be a general-purpose home automation hub, or an application-specific hub, such as a security hub, an energy management hub, an HVAC hub, and so forth. The functionality of the hub 746 may also be integrated into any wireless network device, such as a network-connected thermostat device or the border router 106. Hosting functionality on the hub 746 in the structure 712 can improve reliability when a user's internet connection is unreliable, can reduce latency of operations that would normally have to connect to the cloud service 112, and can satisfy system and regulatory constraints around local access between wireless network devices.

Additionally, the example environment 700 includes a network-connected speaker 748. The network-connected speaker 748 provides voice assistant services that include providing voice control of network-connected devices. The functions of the hub 746 may be hosted in the network-connected speaker 748. The network-connected speaker 748 can be configured to communicate via the HAN, which may include a wireless mesh network, a Wi-Fi network, or both.

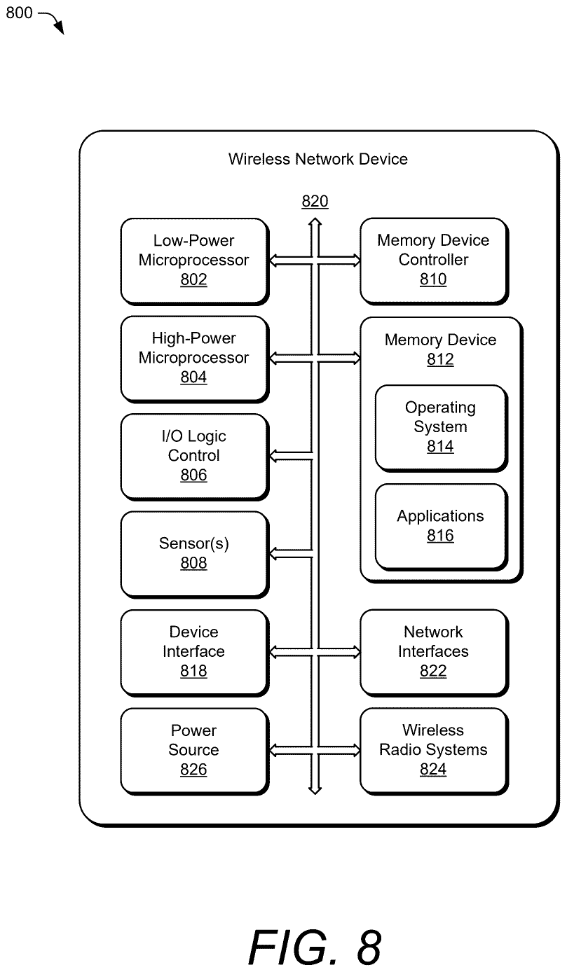

FIG. 8 illustrates an example wireless network device 800 that can be implemented as any of the wireless network devices 102 (e.g., electronic device 202 or other target device) in a HAN in accordance with one or more aspects of a motion-triggered fast shutter and readout as described herein. The device 800 can be integrated with electronic circuitry, microprocessors, memory, input/output (I/O) logic control, communication interfaces and components, as well as other hardware, firmware, and/or software to implement the device in a HAN. Further, the wireless network device 800 can be implemented with various components, such as with any number and combination of different components as further described with reference to the example device 800 shown in FIG. 8.

In this example, the wireless network device 800 includes a low-power microprocessor 802 and a high-power microprocessor 804 (e.g., microcontrollers or digital signal processors) that process executable instructions. The device 800 also includes an input-output (I/O) logic control 806 (e.g., to include electronic circuitry). The microprocessors 802 and 804 can include components of an IC, a programmable logic device, a logic device formed using one or more semiconductors, and other implementations in silicon and/or hardware, such as a processor and memory system implemented as an SoC. Alternatively or in addition, the device can be implemented with any one or combination of software, hardware, firmware, or fixed logic circuitry that may be implemented with processing and control circuits. The low-power microprocessor 802 and the high-power microprocessor 804 can also support one or more different device functionalities of the device. For example, the high-power microprocessor 804 may execute computationally intensive operations, whereas the low-power microprocessor 802 may manage less complex processes such as detecting a hazard or temperature from one or more sensors 808. The low-power microprocessor 802 may also wake or initialize the high-power microprocessor 804 for computationally intensive processes.

The one or more sensors 808 can be implemented to detect various properties such as acceleration, temperature, humidity, water, supplied power, proximity, external motion, device motion, sound signals, ultrasound signals, light signals, fire, smoke, carbon monoxide, global-positioning-satellite (GPS) signals, radio frequency (RF), other electromagnetic signals or fields, or the like. As such, the sensors 808 may include any one or a combination of temperature sensors, humidity sensors, hazard-related sensors, other environmental sensors, accelerometers, microphones, optical sensors up to and including cameras (e.g., charged coupled-device or video cameras), active or passive radiation sensors, GPS receivers, and RF identification detectors. In implementations, the wireless network device 800 may include one or more primary sensors, as well as one or more secondary sensors, such as primary sensors that sense data central to a core operation of the device (e.g., sensing a temperature in a thermostat or sensing smoke in a smoke detector) and secondary sensors that may sense other types of data (e.g., motion, light or sound), which can be used for energy-efficiency objectives or automation objectives.

The wireless network device 800 includes a memory device controller 810 and a memory device 812, such as any type of a nonvolatile memory and/or another suitable electronic data storage device. The wireless network device 800 can also include various firmware and/or software, such as an operating system 814 that is maintained as computer-executable instructions by the memory device 812 and executed by a microprocessor. The device software may also include one or more applications 816 (e.g., applications 210) that implement various functionalities of the wireless network device 800. The wireless network device 800 also includes a device interface 818 to interface with another device or peripheral component and includes an integrated data bus 820 that couples the various components of the wireless network device 800 for data communication between the components. The data bus 820 in the wireless network device 800 may also be implemented as any one or a combination of different bus structures and/or bus architectures.

The device interface 818 may receive input from a user and/or provide information to the user (e.g., as a user interface), and a received input can be used to determine a setting. The device interface 818 may also include mechanical or virtual components that respond to a user input. For example, the user can mechanically move a sliding or rotatable component, or a motion along a touchpad may be detected, and such motions may correspond to a setting adjustment of the device 800. Physical and virtual movable user-interface components can allow the user to set a setting along a portion of an apparent continuum. The device interface 818 may also receive inputs from any number of peripherals, such as buttons, a keypad, a switch, a microphone, and an imager (e.g., a camera device).

The wireless network device 800 can include network interfaces 822 (e.g., network interface 214), such as a HAN interface for communication with other wireless network devices in a HAN, and an external network interface for network communication, such as via the Internet. The wireless network device 800 also includes wireless radio systems 824 for wireless communication with other wireless network devices via the HAN interface and for multiple, different wireless communications systems. The wireless radio systems 824 may include Wi-Fi, Bluetooth™, Mobile Broadband, Bluetooth Low Energy (BLE), and/or point-to-point IEEE 802.15.4. Each of the different radio systems can include a radio device, antenna, and chipset that is implemented for a particular wireless communications technology. The wireless network device 800 also includes a power source 826, such as a battery (e.g., battery 204) and/or a cable to connect the device 800 to line voltage. An alternating current (AC) power source may also be used to charge the battery of the device.

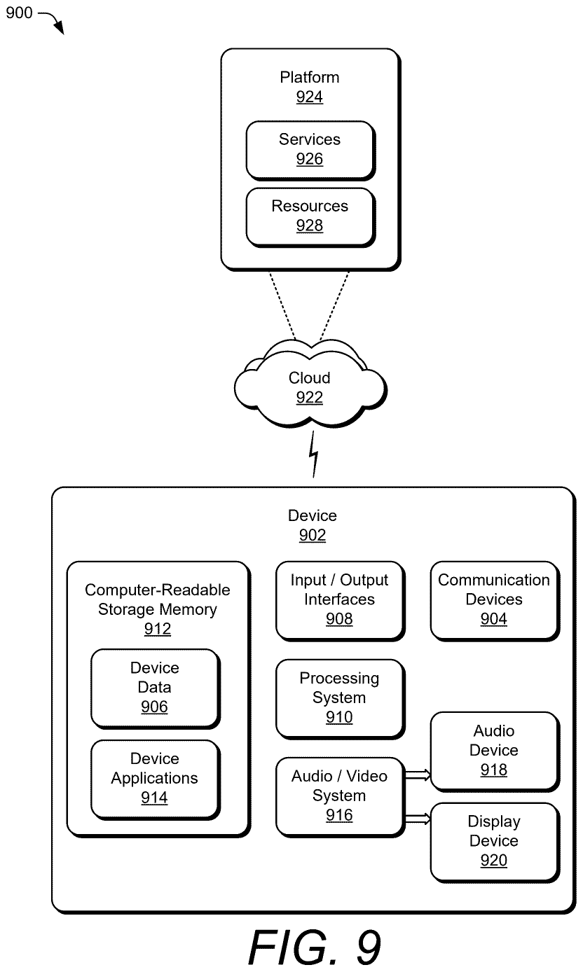

FIG. 9 illustrates an example system 900 that includes an example device 902, which can be implemented as any of the wireless network devices 102 (e.g., electronic device 202 or other target device) that implement aspects of a motion-triggered fast shutter and readout as described with reference to the previous FIGS. 1 to 8. The example device 902 may be any type of computing device, client device, mobile phone, tablet, communication, entertainment, gaming, media playback, and/or other type of device. Further, the example device 902 may be implemented as any other type of wireless network device that is configured for communication on a HAN, such as a thermostat, hazard detector, camera, lighting unit, commissioning device, router, border router, joiner router, joining device, end device, leader, or access point, and/or other wireless network devices.

The device 902 includes communication devices 904 that enable wired and/or wireless communication of device data 906, such as data that is communicated between devices in a HAN, data that is being received, data scheduled for broadcast, data packets of the data, data that is synchronized between the communication devices 904, etc. The device data 906 can include any type of communication data, as well as audio, video, and/or image data that is generated by applications executing on the device 902. The communication devices 904 can also include transceivers for cellular phone communication and/or for network data communication.

The device 902 also includes input/output (I/O) interfaces 908, such as data network interfaces (e.g., network interface 214) that provide connection and/or communication links between the device 902, data networks (e.g., a HAN, external network, etc.), and other devices. The I/O interfaces 908 can be used to couple the device 902 to any type of components, peripherals, and/or accessory devices. The I/O interfaces 908 also include data input ports via which any type of data, media content, and/or inputs can be received, such as user inputs to the device 902, as well as any type of communication data, as well as audio, video, and/or image data received from any content and/or data source.

The device 902 includes a processing system 910 (e.g., processors 206) that may be implemented at least partially in hardware, such as with any type of microprocessors, controllers, and the like that process executable instructions. The processing system can include components of an IC, a programmable logic device, a logic device formed using one or more semiconductors, and other implementations in silicon and/or hardware, such as a processor and memory system implemented as an SoC. Alternatively or in addition, the device 902 can be implemented with any one or combination of software, hardware, firmware, or fixed logic circuitry that may be implemented with processing and control circuits. The device 902 may further include any type of a system bus or other data and command transfer system that couples the various components within the device 902. A system bus can include any one or combination of different bus structures and architectures, as well as control and data lines.

The device 902 also includes computer-readable storage memory 912 (e.g., CRM 208), such as data storage devices that can be accessed by a computing device and that provide persistent storage of data and executable instructions (e.g., software applications, modules, programs, functions, and the like). The computer-readable storage memory 912 described herein excludes propagating signals. Examples of computer-readable storage memory include volatile memory and non-volatile memory, fixed and removable media devices, and any suitable memory device or electronic data storage that maintains data for computing device access. The computer-readable storage memory 912 can include various implementations of random access memory (RAM), read-only memory (ROM), flash memory, erasable programmable read-only memory (EPROM), electrically erasable programmable read-only memory (EEPROM), and other types of storage memory in various memory device configurations.

The computer-readable storage memory 912 provides storage of the device data 906 and various device applications 914 (e.g., applications 210), such as an operating system (e.g., operating system 212) that is maintained as a software application with the computer-readable storage memory 912 and executed by the processing system 910. The device applications 914 may also include a device manager, such as any form of a control application, a software application, a signal processing and control module, code that is native to a particular device, a hardware abstraction layer for a particular device, and so on.

The device 902 also includes an audio and/or video system 916 that generates audio data for an audio device 918 and/or generates display data for a display device 920 (e.g., display 220). The audio device 918 and/or the display device 920 include any devices that process, display, and/or otherwise render audio, video, display, and/or image data, such as image content of a digital photo. In implementations, the audio device 918 and/or the display device 920 are integrated components of the example device 902. Alternatively, the audio device 918 and/or the display device 920 are external, peripheral components to the example device 902. In aspects, at least part of the techniques described for a motion-triggered fast shutter and readout may be implemented in a distributed system, such as over a “cloud” 922 in a platform 924. The cloud 922 includes and/or is representative of the platform 924 for services 926 and/or resources 928.

The platform 924 abstracts underlying functionality of hardware, such as server devices (e.g., included in the services 926) and/or software resources (e.g., included as the resources 928), and connects the example device 902 with other devices, servers, etc. The resources 928 may also include applications and/or data that can be utilized while computer processing is executed on servers that are remote from the example device 902. Additionally, the services 926 and/or the resources 928 may facilitate subscriber network services, such as over the Internet, a cellular network, or a Wi-Fi network. The platform 924 may also serve to abstract and scale resources to service a demand for the resources 928 that are implemented via the platform 924, such as in an interconnected device aspect with functionality distributed throughout the system 900. For example, the functionality may be implemented in part at the example device 902 as well as via the platform 924 that abstracts functionality of the cloud 922.

Some examples are described below:

Example 1: A method for implementing motion-triggered fast shutter and readout, the method comprising: initializing first and second image sensors of an electronic device, the first and second image sensors sharing a same field of view and being synchronized together by a microcontroller of the electronic device; generating image data using each of the first and second image sensors, the second image sensor using a higher frame rate and a lower resolution than the first image sensor; detecting, by the second image sensor, a moving object within the field of view; responsive to detecting the moving object, determining, by the second image sensor, motion information associated with the moving object, the motion information including a speed of the moving object and a region of interest within the field of view that includes the moving object; based on the motion information determined by the second image sensor, increasing a shutter speed and readout of the first image sensor for the region of interest within the field of view to provide additional image data for the region of interest; and generating an image for display based at least on the image data of the first image sensor and the additional image data of the first image sensor for the region of interest.

Example 2: The method of example 1, wherein the first and second image sensors correspond to a lens having a same effective focal length for each of the first and second image sensors.

Example 3: The method of example 1 or example 2, wherein areas of the field of view that are outside the region of interest are captured at a first shutter speed and the region of interest is captured at a second shutter speed that is greater than the first shutter speed.

Example 4: The method of any preceding example, further comprising determining whether the speed of the moving object is greater than a threshold value, wherein increasing the shutter speed includes increasing the shutter speed responsive to determining that the speed of the moving object is greater than the threshold value.

Example 5: The method of any preceding example, further comprising determining whether a size of the moving object in the field of view is greater than a threshold size, wherein increasing the shutter speed includes increasing the shutter speed responsive to determining that the size of the moving object is greater than the threshold size.

Example 6: The method of any preceding example, further comprising determining whether to create a new region of interest for the increased shutter speed to capture the moving object at the increased shutter speed and readout.

Example 7: The method of any preceding example, wherein the first image sensor uses a global shutter on the region of interest at the increased shutter speed and readout and uses a rolling shutter on areas of the field of view outside the region of interest.

Example 8: The method of any one of examples 1 to 6, further comprising providing, by the second image sensor, the motion information to the first image sensor to cause the first image sensor to increase a frame rate used on the region of interest.

Example 9: The method of example 8, wherein providing the motion information includes providing the motion information to the first image sensor through register parameters over one or more communication links between the first and second image sensors.

Example 10: The method of any preceding example, further comprising translating the region of interest detected by the second image sensor at the lower resolution into a corresponding area for the first image sensor at a higher resolution.

Example 11: The method of any preceding example, further comprising separating the region of interest from other operations of the first image sensor by using a dedicated analog-to-digital converter circuitry that is independent of an analog-to-digital converter circuitry of the first image sensor that is used for an entire pixel array of the first image sensor.

Example 12: The method of example 11, further comprising providing additional analog-to-digital readouts for the region of interest using the dedicated analog-to-digital converter circuitry.

Example 13: The method of any preceding example, further comprising integrating and sampling first pixels of the first image sensor that are inside the region of interest independently from and at a higher rate than second pixels of the first image sensor that are outside the region of interest.

Example 14: The method of any preceding example, further comprising: sending sampled data from the region of interest to a separate on-sensor memory of the first image sensor; packetizing the sampled data with virtual identifiers and metadata to provide packetized data; and transmitting the packetized data over a virtual channel to the microcontroller for processing.

Example 15: A camera device comprising: a controller configured to synchronize a plurality of image sensors; a first image sensor of the plurality of image sensors, the first image sensor configured to capture images; and a second image sensor of the plurality of image sensors, the second image sensor having a same field of view as the first image sensor and a smaller resolution than the first image sensor, wherein the controller, the first image sensor, and the second image sensor are configured to collectively perform the method of any one of examples 1 to 14.

### CONCLUSION

Although aspects of motion-triggered fast shutter and readout have been described in language specific to features and/or methods, the subject of the appended claims is not necessarily limited to the specific features or methods described. Rather, the specific features and methods are disclosed as example implementations of the techniques for motion-triggered fast shutter and readout, and other equivalent features and methods are intended to be within the scope of the appended claims. Further, various aspects are described, and it is to be appreciated that each described aspect can be implemented independently or in connection with one or more other described aspects.

1. A method for implementing motion-triggered fast shutter and readout, the method comprising:
initializing first and second image sensors of an electronic device, the first and second image sensors sharing a same field of view and being synchronized together by a microcontroller of the electronic device;
generating image data using each of the first and second image sensors, the second image sensor using a higher frame rate and a lower resolution than the first image sensor;
detecting, by the second image sensor, a moving object within the field of view;
responsive to detecting the moving object, determining, by the second image sensor, motion information associated with the moving object, the motion information including a speed of the moving object and a region of interest within the field of view that includes the moving object;
based on the motion information determined by the second image sensor, increasing a shutter speed and readout of the first image sensor for the region of interest within the field of view to provide additional image data for the region of interest; and
generating an image for display based at least on the image data of the first image sensor and the additional image data of the first image sensor for the region of interest.

2. The method of claim 1, wherein the first and second image sensors correspond to a lens having a same effective focal length for each of the first and second image sensors.

3. The method of claim 1, wherein areas of the field of view that are outside the region of interest are captured at a first shutter speed and the region of interest is captured at a second shutter speed that is greater than the first shutter speed.

4. The method of claim 1, further comprising determining whether the speed of the moving object is greater than a threshold value, wherein increasing the shutter speed includes increasing the shutter speed responsive to determining that the speed of the moving object is greater than the threshold value.

5. The method of claim 1, further comprising determining whether a size of the moving object in the field of view is greater than a threshold size, wherein increasing the shutter speed includes increasing the shutter speed responsive to determining that the size of the moving object is greater than the threshold size.

6. The method of claim 1, further comprising determining whether to create a new region of interest for the increased shutter speed to capture the moving object at the increased shutter speed and readout.

7. The method of claim 1, wherein the first image sensor uses a global shutter on the region of interest at the increased shutter speed and readout and uses a rolling shutter on areas of the field of view outside the region of interest.

8. The method of claim 1, further comprising providing, by the second image sensor, the motion information to the first image sensor to cause the first image sensor to increase a frame rate used on the region of interest.

9. The method of claim 8, wherein providing the motion information includes providing the motion information to the first image sensor through register parameters over one or more communication links between the first and second image sensors.

10. The method of claim 1, further comprising translating the region of interest detected by the second image sensor at the lower resolution into a corresponding area for the first image sensor at a higher resolution.

11. The method of claim 1, further comprising separating the region of interest from other operations of the first image sensor by using a dedicated analog-to-digital converter circuitry that is independent of an analog-to-digital converter circuitry of the first image sensor that is used for an entire pixel array of the first image sensor.

12. The method of claim 11, further comprising providing additional analog-to-digital readouts for the region of interest using the dedicated analog-to-digital converter circuitry.

13. The method of claim 1, further comprising integrating and sampling first pixels of the first image sensor that are inside the region of interest independently from and at a higher rate than second pixels of the first image sensor that are outside the region of interest.

14. The method of claim 1, further comprising:
sending sampled data from the region of interest to a separate on-sensor memory of the first image sensor;
packetizing the sampled data with virtual identifiers and metadata to provide packetized data; and
transmitting the packetized data over a virtual channel to the microcontroller for processing.

15. (canceled)

16. A camera device comprising:
a first image sensor configured to capture images;
a second image sensor sharing a same field of view as the first image sensor, the second image sensor configured to:
use a higher frame rate and a lower resolution than the first image sensor;
detect a moving object within the field of view; and
responsive to detection of the moving object, determine motion information associated with the moving object, the motion information including a speed of the moving object and a region of interest within the field of view that includes the moving object; and
a controller configured to:
synchronize the first and second image sensors;
generate image data using each of the first and second image sensors;
based on the motion information determined by the second image sensor, increase a shutter speed and readout of the first image sensor for the region of interest within the field of view to provide additional image data for the region of interest; and
generate an image for display based at least on the image data of the first image sensor and the additional image data of the first image sensor for the region of interest.

17. The camera device of claim 16, wherein the first and second image sensors correspond to a lens having a same effective focal length for each of the first and second image sensors.

18. The camera device of claim 16, wherein areas of the field of view that are outside the region of interest are captured at a first shutter speed and the region of interest is captured at a second shutter speed that is greater than the first shutter speed.

19. The camera device of claim 16, wherein:
the second image sensor is configured to determine whether the speed of the moving object is greater than a threshold speed or whether a size of the moving object in the field of view is greater than a threshold size; and
the controller is configured to increase the shutter speed responsive to a first determination that the speed of the moving object is greater than the threshold speed or responsive to a second determination that the size of the moving object is greater than the threshold size.

20. The camera device of claim 16, wherein the first image sensor uses a global shutter on the region of interest at the increased shutter speed and readout and uses a rolling shutter on areas of the field of view outside the region of interest.

21. The camera device of claim 16, wherein:
the second image sensor is configured to provide the motion information to the first image sensor to cause the first image sensor to increase a frame rate used on the region of interest; and
the motion information is provided through register parameters over one or more communication links between the first and second image sensors.
